(19) United States
(12) Patent Application Publication
(10) Pub. No.: US 2006/0194060 A1
(43) Pub. Date: Aug. 31, 2006

(54) Furnace spacers for spacing preforms in a furnace

(75) Inventors: Alan A. Arico, South Bend, IN (US); David E. Parker, Granger, IN (US); Akshay Waghray, Granger, IN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL

(21) Appl. No.: 11/359,473

(22) Filed: Feb. 23, 2006

Related U.S. Application Data
(60) Provisional application No. 60/656,082, filed on Feb. 25, 2005.
(60) Provisional application No. 60/664,587, filed on Mar. 24, 2005.

(51) Int. Cl. B32B 9/00; B32B 17/10; C04B 35/64

(52) U.S. Cl. 428/408; 428/409; 264/605

(57) ABSTRACT

A set of furnace spacers for spacing a first preform from a second preform, the first and second preforms each having an outer periphery, a width, an inner opening having a periphery and a width, a first side defined by the outer periphery and said inner opening, the first side having a surface area, and a second side spaced from the first side. Each spacer in the set of spacers has a body having a first side having a surface area, and the sum of the first side surface areas of the spacers in a set is greater than about thirty percent of the preform first side surface area.

### CROSS-REFERENCE TO RELATED APPLICATIONS

The present application claims the benefit of U.S. Provisional Application No. 60/656,082, filed Feb. 25, 2005, and U.S. Provisional Application No. 60/664,587 filed Mar. 24, 2005. The entire contents of both applications are hereby incorporated by reference.

### FIELD OF THE INVENTION

The present invention is directed to spacers for separating adjacent preforms in a furnace, and, more specifically, toward a set of spacers covering at least about thirty percent of the surface of a side of an annular preform and spacing one preform from another during a chemical vapor infiltration/deposition (CVI/CVD) process in a furnace.

### BACKGROUND OF THE INVENTION

Carbon-carbon and/or ceramic matrix composite disks may be used as brake rotors and/or stators in automotive and aircraft brake systems. During the manufacture of these discs, non-woven fiber preforms may be placed in a furnace and subjected to multiple CVI/CVD process cycles. During these process cycles, multiconstituent hydrocarbons and/or other precursor process gases are deposited in the body of the preforms as pyrocarbon or other ceramic matrices. This processing is referred to as “densification” and results in an increase in the density of the preform with each process cycle. The process will be referred to as CVD. Before the first CVD process cycle, for example, the preforms may have a density of about 0.5 g/cc.

Normally, CVD processes are carried out on multiple composite preforms that have been arranged in stacks in a CVD furnace. As illustrated in FIGS. 27 and 28, for example, the composite preforms 200 are generally annular or ring shaped, and these preforms must be spaced from adjacent preforms to allow gases to flow around and into them during processing. A plurality of separate spacer elements, such as round spacers 202 illustrated in FIG. 27 and rectangular spacers 204 illustrated in FIG. 28, are placed between each pair of preforms so as not to interfere with process gas flow around the preforms, and so as not to block gas flow into the preforms.

The total surface area of the preforms covered by the spacers is kept low to avoid interfering with process gas flow. However, if the spacers are made too small, they tend to leave indentations in the preforms that must be machined off. In some cases, the indentations are too deep to be removed completely, and preforms with such deep indentations must be discarded. Therefore, typical spacers generally cover about 10 to 20 percent of the surface area of a preform. This level of coverage was generally believed to provide enough support to keep indentations small while not interfering significantly with process gas flow. In some cases, when using these small spacers, however, it is necessary to limit the height of a stack of preforms so that the weight of the stack does not damage the preforms at the bottom of the stack. Using less than the full capacity of the processing furnace increases cost and reduces efficiency.

Preforms are generally about 1 to 2 inches thick, and the spacers used when these preforms are processed are generally about one-half inch thick. If the spacers could be made thinner, a greater number of preforms could be processed in a single cycle in a furnace. Tests performed with quarter inch thick spacers, however, resulted in inferior finished disks, and it was believed that the smaller spaces between preforms created by the thinner spacers was interfering with process gas flow between the preforms.

It would therefore be desirable to provide a spacer that reduces the occurrence of unacceptably deep indentations and which does not interfere with a densification process.

### SUMMARY OF THE INVENTION

These problems and others are addressed by the present invention, which comprises, in a first aspect, a set of furnace spacers for spacing a first preform from a second preform, the first and second preforms each having an outer periphery, a width, an inner opening having a periphery and a width, a first side defined by the outer periphery and the inner opening and having a surface area, and a second side spaced from the first side. Each spacer in the set has a body with a first surface, and the sum of the surface areas of the spacer first surfaces in a set is greater than about thirty percent of the preform first side surface area.

Another aspect of the invention comprises a stack comprising a plurality of preforms and a plurality of sets of spacers stacked for treatment in a furnace. Each preform is formed as a disk having a center opening having a width, an outer periphery, and a first side defined by the center opening and the outer periphery and having a surface area. Each spacer comprises a body having a first side having a surface area. The sum of the surface areas of the spacer first sides in one set of the plurality of sets is greater than about thirty percent of the preform first side surface area. One set of spacers is disposed between adjacent preforms in the stack.

A further aspect of the invention comprises a method of spacing a first preform from a second preform in a furnace that involves providing first and second annular preforms each having a center opening having a width, an exterior periphery and a first side surface having an area, and placing the first annular preform on a support. A plurality of spacers is also provided, each comprising a body having a first side having a surface area. The set of spacers is placed on the first annular preform to cover at least about thirty percent of preform first side surface, and the second annular preform is placed on the plurality of spacers. The first and second annular preforms and the set of the plurality of spacers is then placed into a furnace.

### BRIEF DESCRIPTION OF THE DRAWINGS

These and other aspects of the invention will be better understood after a reading of the detailed description provided below together with the following drawings, wherein:

FIG. 1 is a plan view of a preform supporting a plurality of spacers according to a first embodiment of the invention;

FIG. 2 is a plan view of a preform supporting a plurality of spacers according to a second embodiment of the invention;

FIG. 3 is a plan view of a preform supporting a plurality of spacers according to a third embodiment of the invention;

FIG. 4 is a plan view of a preform supporting a plurality of spacers according to a fourth embodiment of the invention;

FIG. 5 is a plan view of one of the spacers illustrated in FIG. 1;

FIG. 6 is a side elevational view of the spacer of FIG. 5;

FIG. 7 is a plan view of a modified version of one of the spacers of FIG. 1;

FIG. 8 is a side elevational view of the spacer of FIG. 7;

FIG. 9 is a plan view of one of the spacers illustrated in FIG. 2;

FIG. 10 is a side elevational view of the spacer of FIG. 9;

FIG. 11 is a plan view of a modified version of the spacer of FIG. 2;

FIG. 12 is a side elevational view of the spacer of FIG. 11;

FIG. 13 is a plan view of one of the spacers illustrated in FIG. 3;

FIG. 14 is a side elevational view of the spacer of FIG. 13;

FIG. 15 is a plan view of a first modified version of the spacer of FIG. 13;

FIG. 16 is a side elevational view of the spacer of FIG. 15;

FIG. 17 is a plan view of a second modified version of the spacer of FIG. 13;

FIG. 18 is a side elevational view of the spacer of FIG. 17;

FIG. 19 is a plan view of one of the spacers illustrated in FIG. 4;

FIG. 20 is a side elevational view of the spacer of FIG. 19;

FIG. 21 is a plan view of a first modified version of the spacer of FIG. 19;

FIG. 22 is a side elevational view of the spacer of FIG. 21;

FIG. 23 is a plan view of a second modified version of the spacer of FIG. 19;

FIG. 24 is a side elevational view of the spacer of FIG. 23;

FIG. 25 schematically illustrates a stack of preforms in a furnace with pairs of adjacent preforms spaced by a plurality of the preforms of FIG. 5;

FIG. 26 is a perspective view of a preform supporting a plurality of the spacers of FIG. 5;

FIG. 27 is a plan view of a preform supporting three round conventional spacers; and

FIG. 28 is a plan view of a preform supporting three rectangular conventional spacers.

### DETAILED DESCRIPTION

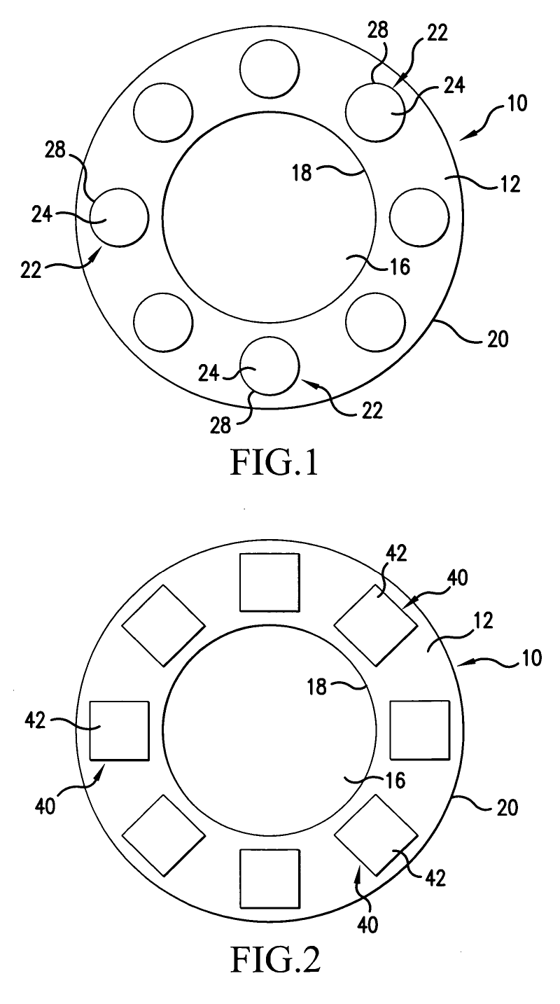

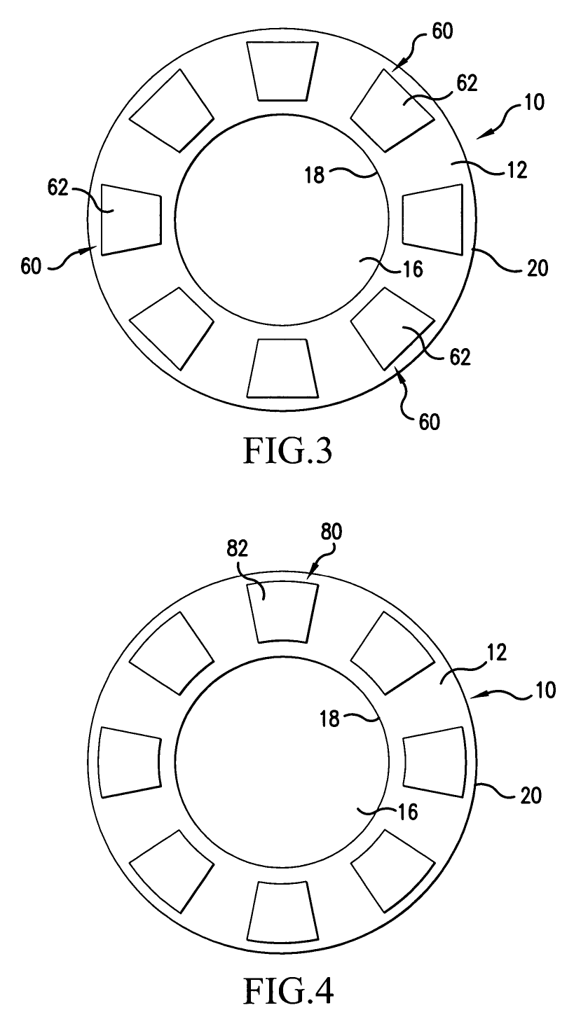

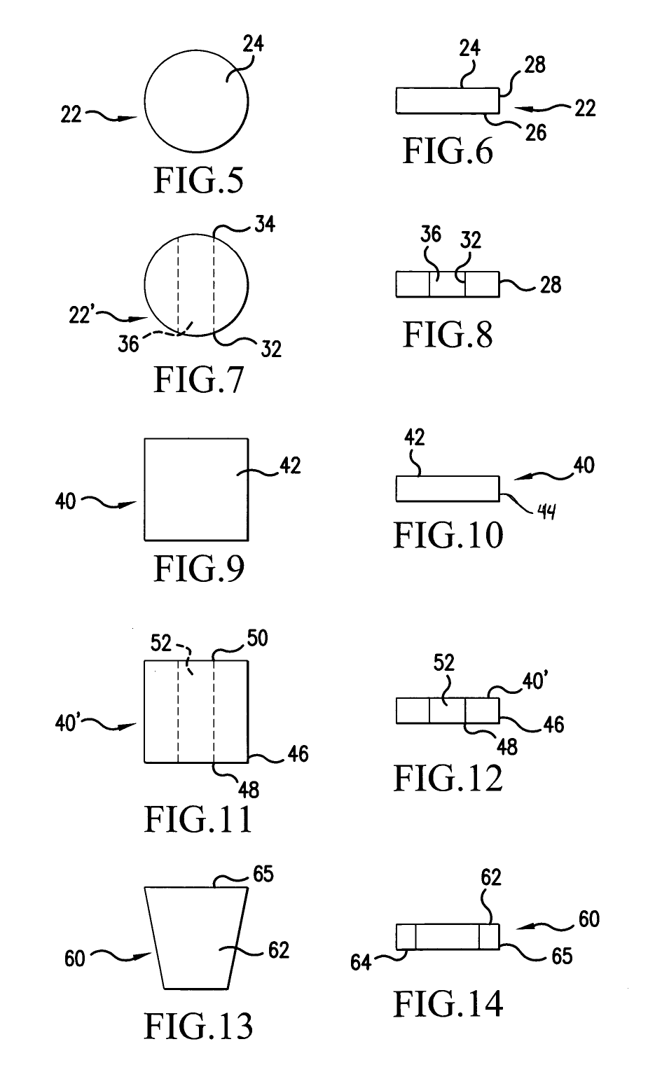

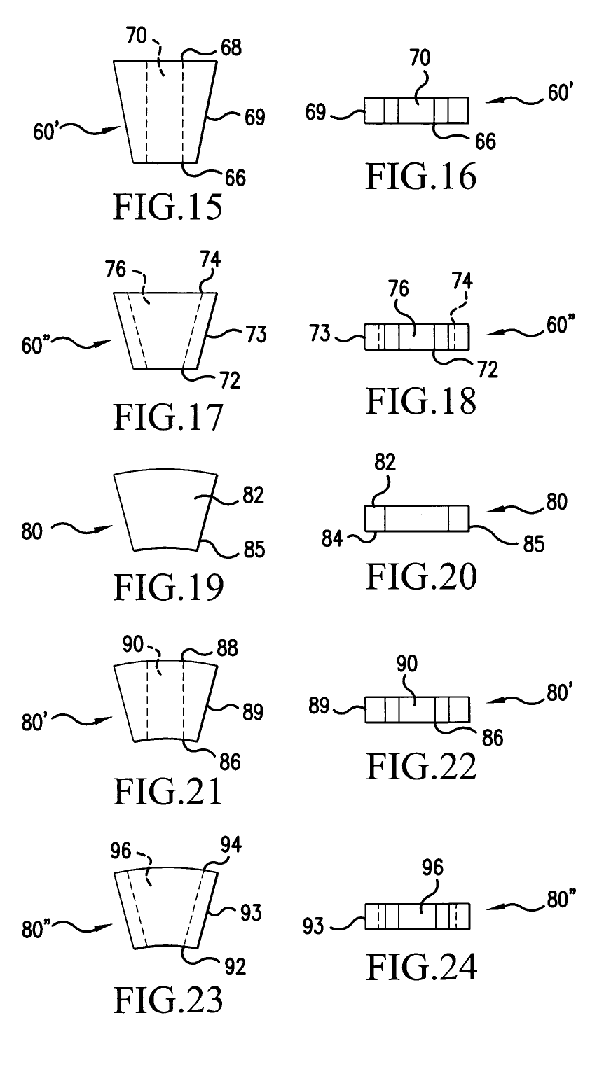

Referring now to the drawings, wherein the showings are for the purpose of illustrating preferred embodiments of the invention only and not for the purpose of limiting same, FIGS. 1 and 26 illustrate a preform 10 that includes a first side 12 and a second side 14 spaced from the first side and substantially identical thereto. The preform includes a central opening 16 having a width and being defined by an inner peripheral wall 18, and the preform 10 also includes an outer peripheral wall 20. The preform first and second sides 12, 14 are generally planar and mutually parallel. As used herein, the surface area of a side of the preform will be the area of the plane bounded by the central opening 18 and the outer peripheral wall 20 without regard to surface ridges, indentations or openings, in the first side of the preform, for example.

A set of spacers 22 according to a first embodiment of the present invention is shown resting on a preform 10 in FIGS. 1 and 26, and an individual one of these spacers 22 is illustrated in FIGS. 5 and 6. Spacer 22 comprises a disk having a first side 24, a second side 26, a peripheral wall 28 and a thickness, which, in the present embodiment, is about one-quarter to one-half inch. The spacers 22 are evenly distributed over the first side 12 of preform 10, although other arrangements and spacings are also possible. According to the present embodiment, the surface area of the spacers 22, specifically, the area of the plane bounded by peripheral wall 28 (again, without regard to any ridges or openings in the surface of the spacer) is selected with reference to the surface area of preform first side 12. Specifically, the set of spacers to be used between pairs of adjacent preforms 10 when the preforms 10 are stacked is selected so that the spacers 22 will cover more than about 30 percent of the surface area of preform first side 12. More specifically, the spacers should cover from about 30 percent to about 60 percent of the surface area of first side of the preform.

In FIG. 1, the set of spacers 22 comprises eight spacers 22, making the surface area of each individual spacer equal to about 3.75 to 7.5 percent of the surface area of first side 12 of preform 10. More or fewer spacers can be used as long as the total surface area covered by the spacers remains greater than about 30 percent and specifically, from about 30 to about 60 percent of the area of one side 12 of preform 10. The number of spacers depends in part on convenience, since it requires more time to position a larger number of spacers, and on obtaining an even distribution of spacers for adequate support, since, for example, three larger spacers might leave overly large gaps therebetween. It is believed that using a set of eight spacers provides a good balance between ease of placement and support for preforms 10.

Spacers 22 cover a larger percentage of the first side 12 of the preform than the conventional spacers 204 illustrated in FIG. 28. It has generally been believed that larger spacers would interfere with the flow of process gas around the preforms and would be undesirable. However, the present inventors have discovered that spacers also function as heat sinks during CVI/CVD processing and absorb heat from the walls of the CVI/CVD furnace. The heat in the spacers sets up a thermal gradient in the preforms and keeps the centers of the annular preform disks hot while the gas that is admitted to the furnace at ambient conditions cools the inner and outer diameters of the disks. The gas diffusing through the porous preforms from the inner and outer diameters deposits carbon faster in the regions of the preforms, which are at a higher temperature, and slower at the regions away from the preforms, which are at lower temperatures. This results in an efficient and more uniform densification of the disks. The efficiency is realized by achieving a higher final density in fewer cycles. Thus, while the spacer of this embodiment of the invention covers a greater portion of the surface area of a preform than previously used spacers and interferes with gas circulation to a greater extent than previous spacers, these problems are more than overcome by 1) the reduced incidence of indentations in the preforms and 2) the more effective densification that occurs when heat from the heatsink/spacers is provided to the preforms, especially the central portions thereof. To function adequately as a heat sink, the spacer should generally have a density at least about three times the density of the preform before densification begins.

Another aspect of the invention is the use of thinner spacers than was heretofore believed possible. Tests had suggested that when conventional spacers, such as those illustrated in FIG. 28, were made thinner than about one-half inch, the densification process would suffer because adequate gas circulation between the preforms would not be possible. However, when gas circulation rates were increased in an effort to compensate for the use of thinner spacers, the density of the preforms unexpectedly decreased. This suggested that some other mechanism was involved in the densification process that was not fully understood.

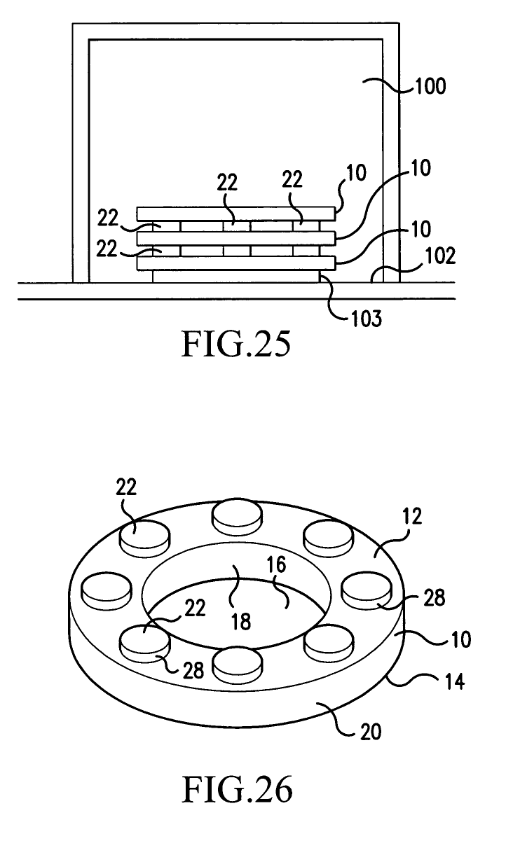

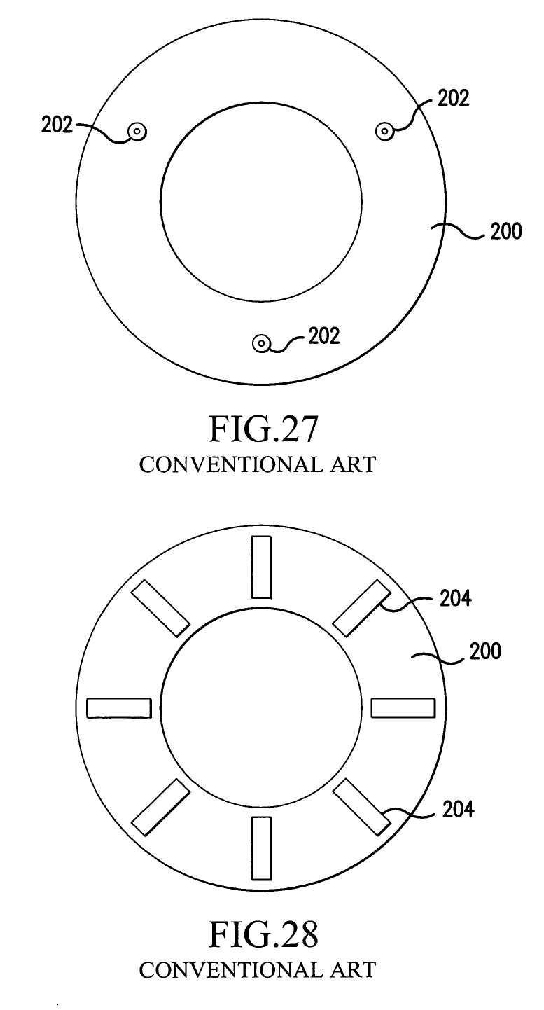

Separately, a preform that had been subject to one cycle of CVI/CVD processing using half inch thick spacers was examined at a microscopic level, and it was found that the parts of the preform where the spacer had been in contact with the preform were of better quality than the surrounding areas that were not in contact with a preform. It was thought that the heat absorbed by the spacer might play a role in this improved structure, and larger spacers, such as those discussed above were thereafter produced and tested. These tests confirmed that larger half inch spacers, covering, for example, about 30 to about 60 percent of one surface of a preform, provided better densification than conventional spacers. Moreover, it was found, surprisingly, that even quarter inch spacers covering about 30 to about 60 percent of the surface area of a preform provided better (or at least comparable) results to those obtained with conventional half inch spacers. Therefore, spacers 22 and spacers according to other embodiments of the invention can be made anywhere from a conventional half inch thickness down to at least as thin as about one-quarter inch and still provide good results. As will be apparent from the above discussion and from the structure of the furnace in which the preforms and spacers are stacked, illustrated schematically in FIG. 25, thinner spacers allow a greater number of preforms to be stacked in a furnace and thus increase processing efficiency. The larger spacers also better distribute the weight of the preforms in the stack and allow taller stacks to be processed.

FIGS. 7 and 8 illustrate a modified version 22′ of the spacer 22 discussed above. A spacer 22′ includes a first opening 32 in its peripheral outer wall 28, a second opening 34 in its peripheral outer wall 28, and a passage or channel 36 connecting the first and second openings 32, 34 and allowing gas to flow through the spacer 22. This version reduces the mass of the preform to some extent, but may provide for better process gas flow throughout the furnace. Spacers 22′ having a channel 36 will generally be arranged in a furnace so that the centerline of the channel is approximately aligned with a radius of the preform 10.

A second embodiment of the invention is illustrated in FIGS. 2, 9 and 10 in which elements common to the first embodiment, specifically, preform 10, are designated with the same reference numerals used in the first embodiment. In this embodiment, square spacers 40 are provided which have first and second opposite sides 42, 44 that are generally planar and parallel to one another. These spacers may have various thicknesses as discussed above in connection with the spacers of the first embodiment and are selected to cover a similar portion of first side 12 of preform 10, specifically, more than about 30 percent of the surface area and more specifically, from about 30 to about 60 percent of the surface area.

A modified version of the square preform 40, designated preform 40′ is illustrated in FIGS. 11 and 12. Preform 40′ includes a peripheral wall 46 having a first opening 48, a second opening 50 spaced from first opening 48, and a channel 52 connecting the first and second openings 48, 50. This channel may improve gas circulation in a furnace in which the spacers are used.

A third embodiment of the invention is disclosed in FIG. 3, 13 and 14, wherein a spacer 60 having a trapezoidal first side 62 and a trapezoidal second side 64 and a peripheral wall 65 is illustrated. These spacers 60 are otherwise similar in size and thickness to the previously described spacers and are arranged on a preform 10 in a similar manner.

A first modified version of spacer 60, designated spacer 60′ is illustrated in FIGS. 15 and 16. Spacer 60′ includes a first opening 66 and a second opening 68 in a peripheral wall 69 connected by a channel 70. This channel may improve gas circulation in a furnace in which the spacers are used. Channel 70 has a substantially constant width between first opening 66 and second opening 68.

A second modified version of spacer 60, designated spacer 60″ is illustrated in FIGS. 17 and 18. Spacer 60″ includes a first opening 72 in a peripheral wall 73 and a second opening 74 in peripheral wall 73 that is larger than first opening 72, and a passage 76 connecting the first and second openings 72, 74. This passage should provide for good gas circulation in a furnace in which a set of spacers 60″ is used.

A fourth embodiment of the invention is illustrated in FIGS. 4, 19 and 20, wherein a spacer 80 having a sector shaped first side 82 and a sector shaped second side 84 in a peripheral wall 85 is disclosed. These spacers 80 are otherwise similar in size and thickness to the previously described spacers and are arranged on a preform 10 in a similar manner.

A first modified version of spacer 80, designated 80′ is illustrated in FIGS. 21 and 22. Spacer 80′ includes a first opening 86 and a second opening 88 in a peripheral wall 89 connected by a channel 90. Channel 90 has a substantially constant width between first opening 86 and second opening 88.

A second modified version of spacer 80, designated 80″ is illustrated in FIGS. 23 and 24. Spacer 80″ includes a first opening 92 in a peripheral wall 93 and a second opening 94 in peripheral wall 93 larger than first opening 92, spaced from the first opening, and a passage 96 connecting the first and second openings.

The various embodiments of the invention are used to space adjacent preforms from one another in a stack. While a set of spacers used between preforms would generally be identical, it may sometimes be desirable to use a combination of the different spacers between adjacent preforms or different sets of preforms between different preform layers in a stack.

FIG. 6 illustrates a CVD furnace 100 that includes a floor 102 on which a support, such as a setter plate 103, for supporting a stack of preforms is placed. The “floor” of the furnace illustrated in FIG. 6 may be part of a support hearth plate used for premixing and preheating the process gases. The process gases may be introduced through perforations in this “floor” that are located inside and outside the annulus of the stack. A first preform 10 is supported by setter plate 103, a set of eight spacers 22 is placed on top of the preform 10, and additional preforms 10 and sets of spacers 22 are alternately stacked on the first preform 10. The thickness of preforms 10 will generally vary from somewhat less than one inch to around two inches, depending on the intended use of the finished disk, with a common thickness being around one and one-half inches. While a set of spacers 22 of the first embodiment of the present invention is illustrated, a set of spacers according to any of the foregoing embodiments could be used. A perforated lid (not shown) or an additional spacer or spacers may be placed at the top of the stack at the top of the furnace in a manner known to those of ordinary skill in this field. Moreover, process gases should be introduced into the furnace in a conventional manner, bearing in mind that it may be desirable to keep the residence times of the gas introduced into the interior of the stack and the gas introduced into the furnace surrounding the stack generally equal. The stack may be formed in the furnace or formed outside the furnace and moved into the furnace for processing, in a well known manner. After processing, the preforms and spacers are removed from the furnace 100, and the preforms and spacers are separated.

The present invention has been described herein in terms of several preferred embodiments. However, various additions and modifications to the embodiments will become apparent to those skilled in the relevant arts upon a reading of the foregoing disclosure. It is intended that all such obvious additions and modifications form a part of the present invention to the extent they fall within the scope of the several claims appended hereto.

We claim:

1. A set of furnace spacers for spacing a first preform from a second preform, the first and second preforms each having an outer periphery, a width, an inner opening having a periphery and a width, a first side defined by said outer periphery and said inner opening, said first side having a surface area, and a second side spaced from said first side,
each spacer in said set of spacers comprising a body having first and second surfaces;
wherein the sum of the surface areas of the spacer first surfaces in said set is greater than about thirty percent of the preform first side surface area.

2. The set of spacers of claim 1 wherein the sum of the surface areas of the spacer first surfaces in said set is from about thirty to sixty percent of the preform first side surface area.

3. The set of spacers of claim 2 wherein the surface area of the first side of each spacer in said set is about 3.75 to 7.5 percent of the preform first side surface area.

4. The set of spacers of claim 1 wherein the first surface of at least one spacer in said set of spacers has a shape selected from the group consisting of a square, a circle, a sector, and an isosceles trapezoid.

5. The set of spacers of claim 1 wherein said at least one spacer has a peripheral wall, a first opening in the peripheral wall, a second opening in the peripheral wall spaced from said first opening, and a passage, extending between said first side and said second side, connecting said first opening to said second opening.

6. The set of spacers of claim 4 wherein said at least one spacer has a peripheral wall, a first opening in the peripheral wall, a second opening in the peripheral wall spaced from said first opening, and a passage, extending between said first side and said second side, connecting said first opening to said second opening.

7. The set of spacers of claim 1 wherein each of said spacers is formed from graphite or a carbon-carbon composite.

8. The set of spacers of claim 1 wherein the thickness of each spacer in said set of spacers is less than one-half inch.

9. The set of spacers of claim 1 wherein the thickness of each spacer in said set of spacers is about one-quarter inch.

10. The set of spacers of claim 1 wherein the spacers in the set of spacers are identical.

11. A stack comprising a plurality of preforms and a plurality of sets of spacers stacked for treatment in a furnace,
each preform comprising a disk having a center opening having a width, an outer periphery, and a first side defined by the center opening and the outer periphery and having a surface area; and
each spacer comprising a body having a first side having a surface area, the sum of the surface areas of the first sides of the spacers in one set of said plurality of sets being greater than about thirty percent of the preform first side surface area;
wherein one set of spacers is disposed between adjacent preforms in the stack.

12. The stack of claim 11 wherein the sum of the surface areas of the first sides of the spacers in said one set is from about thirty to sixty percent of the preform first side surface area.

13. The stack of claim 12 wherein:
the first side of at least one spacer in said set of spacers has a shape selected from the group consisting of a square, a circle, a sector, and an isosceles trapezoid;
said at least one spacer has a peripheral wall, a first opening in the peripheral wall, a second opening in the peripheral wall spaced from said first opening, and a passage connecting said first opening to said second opening; and
the spacers in said set of spacers are identical and each have a thickness of about one-quarter inch.

14. A method of spacing a first preform from a second preform in a furnace comprising the steps of:
providing first and second annular preforms each having a center opening having a width, an exterior periphery and a first side surface having an area;
placing the first annular preform on a support;
providing a plurality of spacers each comprising a body having a first side having a surface area;
placing a set of the plurality of spacers on the first annular preform to cover at least about thirty percent of the preform first side surface;
placing the second annular preform on the set of the plurality of spacers; and
placing the first and second annular preforms and the set of the plurality of spacers into a furnace.

15. The method of claim 14 wherein said step of placing a first set of the plurality of spacers on the first annular preform to cover at least about thirty percent of the preform first side surface comprises the step of placing a set of the plurality of spacers on the first annular preform to cover from about thirty percent to about 60 percent of the preform first side surface.

16. The method of claim 14 wherein said step of placing a set of the plurality of spacers on the first annular preform comprises the step of evenly spacing the spacers in the set of the plurality of spacers on the first side of the preform.

17. The method of claim 14 wherein at least some of the plurality of spacers include a channel, and including the additional step of aligning the channel with a radius of the first preform.
